(19) United States
(12) Patent Application Publication
(10) Pub. No.: US 2026/0115827 A1
(43) Pub. Date: Apr. 30, 2026

(54) SYSTEMS AND METHODS FOR MONITORING ON-THE-FLY (OTF) WELDING USING OPTICAL COHERENCE TOMOGRAPHY (OCT)

(71) Applicant: IPG PHOTONICS CORPORATION, Marlborough, MA (US)

(72) Inventors: Marc Andre DROUIN, Marlborough, MA (US); Steffen MUELLER, Marlborough, MA (US); Paul JL WEBSTER, Kingston (CA)

(21) Appl. No.: 19/345,541

(22) Filed: Sep. 30, 2025

Related U.S. Application Data
(60) Provisional application No. 63/705,702, filed on Oct. 10, 2024.

(51) Int. Cl. B23K 26/03; B23K 26/082; B23K 26/24; B23K 31/12; G01B 9/02055; G01B 9/02091

(52) U.S. Cl. CPC B23K 26/032; B23K 26/082; B23K 26/24; B23K 31/12; G01B 9/02063; G01B 9/02091

(57) ABSTRACT

Systems and methods for on-the-fly (OTF) welding using optical coherence tomography (OCT) use measurement and compensation techniques to ensure accuracy of OCT measurements. OTF welding may involve a coordinated motion of a process beam by the process beam head while the process beam head is moved relative to the workpiece to perform, for example, linear OTF welding, rotary OTF welding, or infinite FOV welding. The systems and methods described herein may be used to perform OTF welding in different applications including, for example, in EV battery manufacturing applications for welding battery cells and busbars. OCT may be used to monitor the OTF welding process using an OCT measuring beam directed to the workpiece with the process beam.

### CROSS-REFERENCE TO RELATED APPLICATIONS

This application claims the benefit of co-pending U.S. Provisional Patent Application Ser. No. 63,705,702, filed on Oct. 10, 2024, which is fully incorporated herein by reference.

### TECHNICAL FIELD

The present disclosure relates to monitoring of on-the-fly (OTF) welding using optical coherence tomography (OCT) and more particularly, to measurement and compensation techniques for OCT monitoring of OTF welding to improve accuracy of OCT measurements.

### BACKGROUND INFORMATION

Optical coherence tomography (OCT) may be used to monitor various types of processes by detecting reflections of an imaging (or measuring) beam from a workpiece and using interferometry. One type of OCT, known as inline coherent imaging (ICI), generally involves directing an imaging beam inline with a process beam toward a workpiece and using an interferometer to receive reflections of the imaging beam and produce an output indicative of characteristics of the process and/or workpiece, such as welding keyhole depth. Examples of ICI are described in greater detail in U.S. Pat. Nos. 8,822,875, 9,757,817 and 10,124,410, which are commonly-owned and fully incorporated herein by reference.

Laser welding is one example of a process that may be effectively monitored with OCT or ICI. Laser welds may contain defects, for example, due to process parameters being out of tolerance or natural fluctuations or instabilities in the melt pool and vapor channel or keyhole formed during the welding process. Direct measurement of keyhole or vapor channel penetration may be used for defect detection and may be accomplished using OCT/ICI.

Certain laser welding techniques, such as on-the-fly (OTF) welding, present unique challenges when monitoring with OCT or ICI. Stationary (static mode) welding dictates that a robot arm or gantry robot stop and start at every welding spot, which is slow and does not utilize the full capabilities of the laser. For OTF welding, a processing laser beam (process beam) may be simultaneously guided with combined movement of a robot and the scanning head optics. OTF welding allows for the laser system to process parts while they are in (relative) motion which leads to a higher duty cycle and thus productivity for the laser system. The relative motion may be properly compensated by prerecording the motion and/or by providing an encoder signal to inform a scanner controller about the relative motion between the scanner and the workpiece and performing active compensation. Real-time weld depth measurements using OCT during OTF welding have been challenging, however, because of the accuracy required for measuring penetration into a phase change region or keyhole and the potential for cumulative errors when calculating the motion of the process beam relative to the workpiece.

### SUMMARY

Consistent with one aspect of the present disclosure, a system is provided for on-the-fly (OTF) welding using optical coherence tomography (OCT). The system includes a process laser for generating a process beam and a process beam head configured to direct the process beam to a workpiece and configured to provide motion of the process beam relative to the workpiece in accordance with process beam corrected motion path data for performing a welding operation at a weld site on the workpiece. The system also includes an OCT monitor configured to generate an OCT measuring beam and configured to receive a reflected OCT measuring beam and configured to perform optical coherence tomography and an OCT head configured to direct the OCT measuring beam to the workpiece and configured to provide motion of the OCT measuring beam relative to the workpiece in accordance with measuring beam corrected motion path data for performing measurements at the weld site on the workpiece. A robot system supports the process beam head, the OCT head and the workpiece and is configured to provide relative motion between the process beam head and the OCT head and the workpiece in accordance with robot motion path data to perform OTF welding.

An OTF/OCT control system is coupled to the process laser, the process beam head, the OCT monitor, the OCT head, and the robot system. The OTF/OCT control system is configured to: control the relative motion provided by the robot system between the process beam head and the OCT head and the workpiece using the robot motion path data; control the process beam motion provided by the process beam head using the process beam corrected motion path data, wherein the process beam corrected motion path data is produced, at least in part, by processing the robot motion path data and by applying corrections using at least one non-linear calibration to correct for at least one optical non-ideality; and control the measuring beam motion provided by the OCT head using the measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality.

Consistent with another aspect of the present disclosure, a system is provided for controlling and monitoring on-the-fly (OTF) welding using optical coherence tomography (OCT). The system includes a robot controller configured to control relative motion provided by a robot system between a process beam head and an OCT head and a workpiece using robot motion path data. The system also includes a process beam controller configured to control process beam motion provided by the process beam head using process beam corrected motion path data. The process beam corrected motion path data is produced, at least in part, by processing the robot motion path data and by applying corrections using at least one non-linear calibration to correct for at least one optical non-ideality. The system further includes an OCT measuring beam controller configured to control measuring beam motion provided by the OCT head using measuring beam corrected motion path data. The measuring beam corrected motion path data is produced, at least in part, by processing the robot motion path data combined with process beam actual motion path data and by applying corrections using at least one non-linear calibration to correct for at least one optical non-ideality. The system further includes a laser controller configured to control powering of a laser source.

Consistent with a further aspect of the present disclosure, a system is provided for controlling and monitoring on-the-fly (OTF) welding using optical coherence tomography (OCT). The system includes processing circuitry programmed to: control relative motion provided by a robot system between a process beam head and an OCT head and a workpiece using robot motion path data; control process beam motion provided by the process beam head using process beam corrected motion path data, wherein the process beam corrected motion path data is produced, at least in part, by processing the robot motion path data and by applying corrections using at least one non-linear calibration to correct for at least one optical non-ideality; control measuring beam motion provided by the OCT head using measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality; and control powering of a laser source.

Consistent with yet another aspect of the present disclosure, a non-transitory machine-readable medium is provided including instructions, which when executed, cause processing circuitry to perform operations to: control relative motion provided by a robot system between a process beam head and an OCT head and a workpiece using robot motion path data; control process beam motion provided by the process beam head using process beam corrected motion path data, wherein the process beam corrected motion path data is produced, at least in part, by processing the robot motion path data and by applying corrections using at least one non-linear calibration to correct for at least one optical non-ideality; control measuring beam motion provided by the OCT head using measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality; and control powering of a laser source.

### BRIEF DESCRIPTION OF THE DRAWINGS

These and other features and advantages will be better understood by reading the following detailed description, taken together with the drawings wherein:

FIG. 1 is a schematic diagram of a system for on-the-fly (OTF) welding using optical coherence tomography (OCT), consistent with embodiments of the present disclosure.

FIGS. 2A and 2B are flow diagrams illustrating the data processing, calibrations and motion path planning for OTF welding using OCT, consistent with embodiments of the present disclosure.

FIG. 3 is a perspective view of a process beam head over a workpiece during OTF welding and illustrating the scanner frame of reference and part frame of reference relative to the OTF motion.

FIG. 4A is a plot illustrating an example of the process beam motion path in the part frame of reference for a series of circle welds.

FIG. 4B is a plot illustrating an example of the process beam motion path in the scanner frame of reference for the series of circle welds.

FIGS. 5A and 5B are diagrams illustrating examples of skywriting motion paths for different welds that may be performed with the system for OTF welding using OCT, consistent with embodiments of the present disclosure.

FIG. 6 is a schematic view illustrating examples of OCT measuring beam positioning and motion to perform measurements relative to a process beam and weld keyhole.

FIG. 7A is a schematic view of an OCT system imaging field of view (FOV) along a Z axis and relative to a focal plane of a process beam.

FIG. 7B is a schematic view of optical path length corrections to adjust the imaging FOV of the OCT system as the OCT measuring beam is scanned with the process beam.

FIGS. 8A-8C are graphs illustrating combined process beam and robot/gantry motion path data pre processing by the OCT controller.

FIGS. 9A-9C are graphs illustrating combined process beam and robot/gantry motion path data post processing by the OCT controller.

FIG. 10A is a plot illustrating an example of OCT measurement data (measured depth v. weld length) without compensation.

FIG. 10B is a plot illustrating an example of OCT measurement data (measured depth v. weld length) with compensation.

FIGS. 11A and 12B are plots of a process signal level relative to the scanner X and Y axes, respectively, during OCT Advanced Process Beam Alignment, consistent with an embodiment of the present disclosure.

FIG. 12 is a graph illustrating module completion time as a function of weld speed using an embodiment of a system for OTF welding with OCT, consistent with the present disclosure.

FIGS. 13A-13C are plots illustrating examples of scanner non-linear corrections in the X, Y and Z axes within the scanner field of view to correct for non-idealities, consistent with embodiments of the present disclosure.

FIGS. 14A-14C are plots illustrating examples of OCT non-linear corrections relative to the scanner X and Y axes to correct for non-idealities, consistent with embodiments of the present disclosure.

### DETAILED DESCRIPTION

Systems and methods for on-the-fly (OTF) welding using optical coherence tomography (OCT), consistent with embodiments of the present disclosure, use measurement and compensation techniques to ensure accuracy of the OCT measurements. In general, OTF welding is a process where welding is performed continuously while a workpiece and/or process beam head (also known as the scan head or scanner) is in motion. OTF welding may involve a coordinated motion of a process beam by the process beam head while the process beam head is moved relative to the workpiece to perform, for example, linear OTF welding, rotary OTF welding, or infinite FOV welding. The systems and methods described herein may be used to perform OTF welding in different applications including, for example, in EV battery manufacturing applications for welding battery cells and busbars. OCT may be used to monitor the OTF welding process using an OCT measuring beam directed to the workpiece with the process beam.

Accurate positioning of the OCT measuring beam is important for OCT measurements during the welding process, particularly for keyhole depth measurements. With single-mode lasers, for example, the OCT measuring beam should be placed in the phase change region (i.e., keyhole) with an accuracy of about 10 μm in order to measure penetration. During OTF welding, this location changes based on the motion of the process relative to the material, but this motion cannot be directly measured. This location is instead calculated using a “layered” series of data processing steps that take into account robot motion, scanner mirror motion, scanner lens non-ideality information for the process beam and scanner lens non-ideality for the OCT beam. Each layer contains a finite amount of temporal/spatial errors that, if cumulated uncorrected, would lead to the OCT beam position error exceeding the aforementioned ˜10 μm threshold. In addition, there may be signal and data processing delays between the various components of the system, which may add to the cumulative error of the OCT beam positioning. The measurement and compensation techniques described herein minimize the cumulative temporal and spatial errors that may affect accuracy of OCT measuring beam positioning.

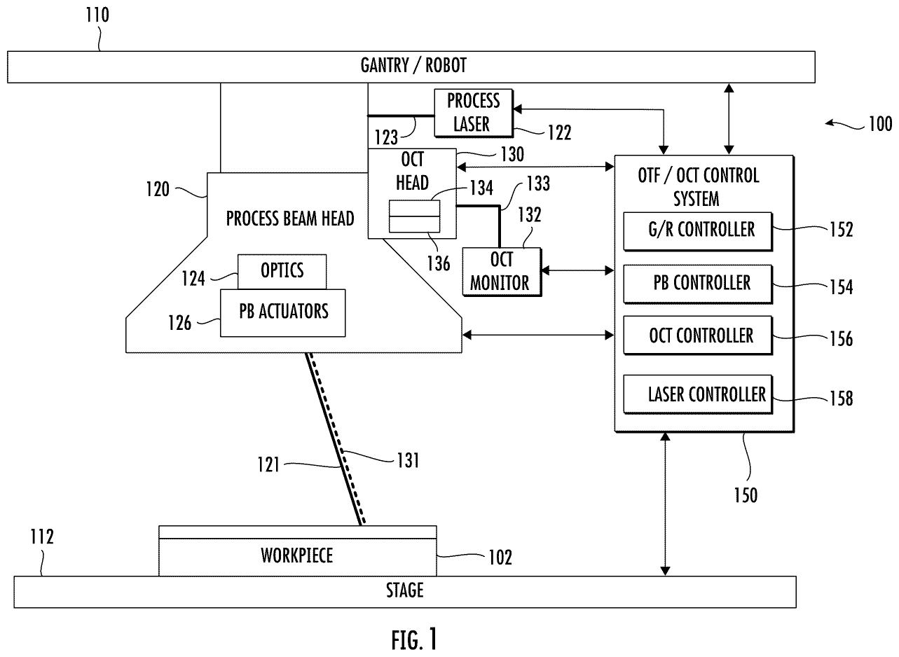

Referring to FIG. 1, a monitored welding system 100 for OTF welding using OCT is described in greater detail. The system 100 generally includes a robot system 110, a process beam head 120, and an OCT head 130. The process beam head 120 is coupled to a process laser 122 that generates a process beam 121, which is directed by the process beam head 120 to a workpiece 102. The process laser 122 may be a single-mode or a multi-mode laser and may be an adjustable mode beam (AMB) laser. The process beam head 120 (also referred to as a scanner) includes beam delivery optics 124 for delivering the process beam 121 to the workpiece and actuators 126 for providing motion of the process beam 121 relative to the workpiece 102 in response to motion commands. The beam delivery optics 124 and actuators 126 may include, for example, collimating lenses, scanning optics (e.g., galvo mirrors), movable lenses, and a focus lens.

The OCT head 130 is coupled to an OCT monitor 132 that includes an OCT beam source (not shown) that generates an OCT measuring beam 131, which is directed by the OCT head 130 to the workpiece 102. The OCT monitor 132 also includes an interferometer and detector (not shown) to perform the optical coherence tomography. The OCT head 130 may also include beam delivery optics 134 and actuators 136 for providing motion of the OCT measuring beam 131 relative to the workpiece 102 in response to motion commands. The OCT head 130 may be integrated with or separate from the process beam head 120.

The robot system 110 supports and moves the process beam head 120 and the OCT head 130 while the process beam 121 and the OCT measuring beam 131 are directed to a processing location (e.g., a weld site) on the workpiece 102. The robot system 110 (also referred to as a robot/gantry) may include an articulating robotic arm supporting and moving the process beam head 120 and the OCT head 130 and/or may include a cartesian gantry robot supporting and moving the process beam head 120 and the OCT head 130. The robot system 110 may further include a stage 112 that supports the workpiece 102 and may also move the workpiece 102 during welding. The robot system 110 may provide relative movement between the process beam 121/OCT measuring beam 131 and the workpiece 102 by moving only the process beam head 120 (with the OCT head 130) while the stage 112 is static, by moving the stage 112 while the process beam head 120 (and OCT head 130) is static, or by moving both the process beam head 120 (with the OCT head 130) and the stage 112. As used herein, the term “robot” refers to the robotic movement of a process beam head and/or an OCT head using any robotic mechanism including, without limitation, a robotic arm or gantry.

The robot system 110, the process beam head 120, the OCT head 130 and the stage 140 may be implemented using known and available equipment. One example of the robot system 110 and the stage 140 includes the EV-Cube Gantry System available from IPG Photonics Inc. One example of the process beam head 120 includes a 3D HP scanner head available from IPG Photonics Inc. and one example of the process laser 122 includes an adjustable mode beam (AMB) laser available from IPG Photonics Inc. An AMB laser is also described in greater detail in U.S. Patent Application Pub. No. 2022/0077648, which is commonly-assigned and incorporated herein by reference. One example of the OCT head 130 and OCT monitor 132 includes the LDD inline weld process monitoring system available from IPG Photonics Inc.

The robot system 110, the process beam head 120 and the OCT head 130 may also include sensing devices, such as encoders, for sensing and providing feedback of actual motion. For example, encoders may be used to measure the actual movement of the actuators in the process beam head 120 and the OCT head 130.

The monitored welding system 100 further includes an OTF/OTC control system 150 for controlling the robot system 110, the process beam head 120, the process laser 122, the OCT head 130 and for performing the measurement and compensation techniques. The OTF/OTC control system 150 commands and controls process beam motion provided by the process beam head 120 using process beam corrected motion path data. The OTF/OTC control system 150 commands and controls measuring beam motion provided by the OCT head 130 using measuring beam corrected motion path data. The OTF/OTC control system 150 may also command and control relative motion provided by the robot system 110 (with or without motion of the stage 112) and may control the triggering (turning on and off) and power of the process laser 122. The OTF/OTC control system 150 uses measurement and compensation techniques that maximize repeatability and accuracy of robot/stage motion, processing beam positioning, laser characteristics, and OCT beam positioning, as will be described in greater detail below.

The control system 150 includes a robot controller 152, a process beam controller 154, an OCT beam controller 156 and a laser controller 158. The controllers 152, 154, 156 may be implemented as separate control units or together as a single control unit. The controllers 152, 154, 156, 158 may include known hardware including processing circuitry and/or software including instructions executed by the processing circuitry. The hardware may include one or more computers and/or microcontrollers programmed with the software to provide the data processing and other functions described herein. The software may be provided on any machine-readable medium including a non-transitory machine-readable medium such as a storage device. The robot controller 152, the process beam controller 154, and the OCT beam controller 156 may be based on the controllers (e.g., hardware and software) used to control the EV-Cube Gantry System, the HP scanner head, and the LDD inline weld process monitoring system described above and programmed with the additional functionality described herein for ensuring accuracy of the OCT measurements.

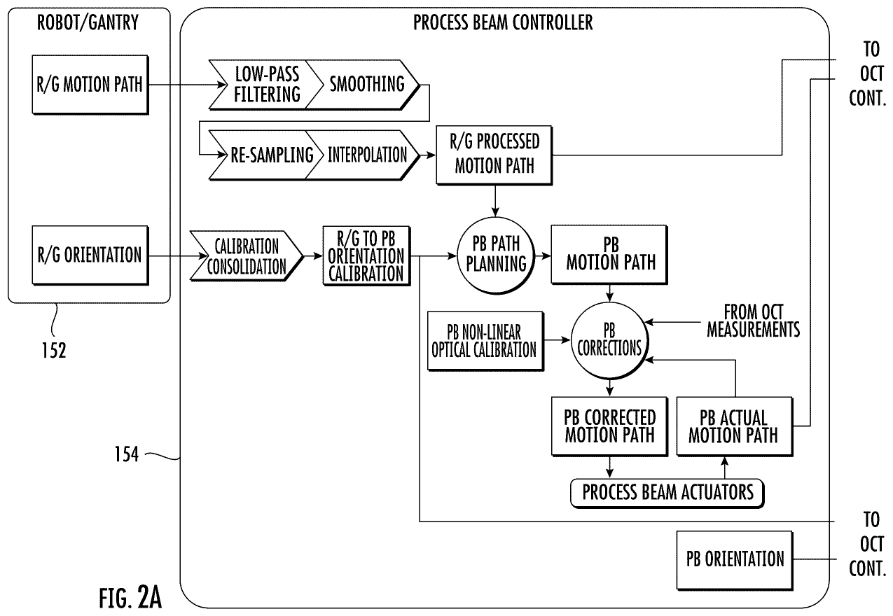

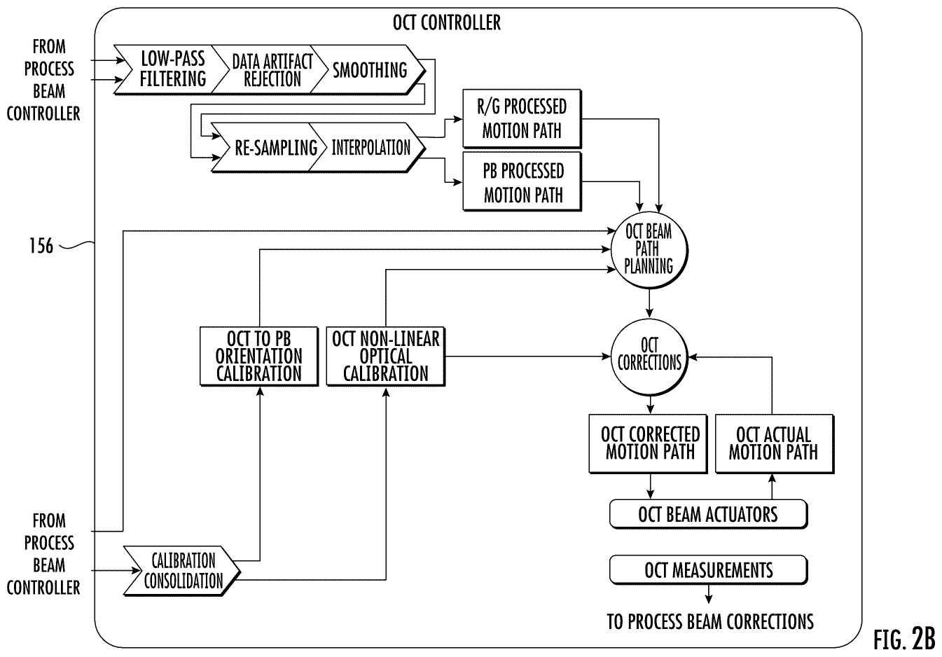

Referring to FIGS. 2A and 2B, an embodiment of the data processing, calibrations and motion path planning performed by the OTF/OTC control system 150 is described in greater detail. The OTF/OTC control system 150 uses measurement and compensation techniques to maximize the repeatability and accuracy of robot motion, processing beam positioning, laser characteristics and OCT beam positioning.

With respect to robot/stage motion, the robot controller 152 commands and controls motion of the robot system 110 (with or without motion of the stage 112) using robot motion path data. As used herein, the robot motion path data (also referred to as robot/gantry motion path data) refers to the data that commands the motion of the process beam head 120 (and OCT head 130) and/or the stage 112 using the robot system 110. The robot motion data may include data defining a motion path of the process beam head 120 (R/G motion path), data defining an orientation of the process beam head 120 (R/G orientation), and/or data defining motion of the stage 112, as a result of robot/stage motion. This two- or three-dimensional spatial and temporal information may be used as an input into the remainder of the OTF/OCT control system 150 for measurement and correction, as will be described in greater detail below.

The robot system 110 typically has a large, three-dimensional working area and can move large distances at speeds slower than the actuators 126 (e.g., scanner mirrors) in the process beam head 120 can move the process beam on their own. Robot/gantry motion may include moving the process beam head 120 relative to a static workpiece 102, moving the workpiece 102 relative to a static process beam head 120, or a combination of motions of both the process beam head 120 and the workpiece 102. Robot systems also can have relatively large spatial accuracy tolerances relative to the commanded motion. Even though there can be large errors in the motion, the actual motion paths are repeatable given a constant command set (both spatially and temporally). Using a high-precision, high-repeatability robot system allows improved accuracy in OCT measurements of a keyhole during an OTF welding process.

The robot system 110 may include a real-time encoder positioning system that allows reading/writing of the position while the process is ongoing. Using the encoders of the system allows for accurate measurements of the position and timing of the motion system as the welding process is ongoing. The robot system 110 is not limited to linear motion and may provide complex motion paths involving translations, rotations, accelerations/decelerations and other dynamic paths.

With respect to process beam positioning, the process beam controller 154 commands and controls the process beam motion provided by the process beam head 120 using process beam corrected motion path data. As will be described in greater detail below, the process beam corrected motion path data is produced, at least in part, by processing the robot motion path data and by applying corrections.

The process beam 121 generated by the laser source 122 exits a fiber optic cable 123 and is optically collimated in the process beam head 120. The process beam actuators 126 in the process beam head 120 may include two galvanometric mirrors to position the beam for lateral motion with respect to the workpiece 102 and may include movable lenses and a lens moving mechanism (e.g., a motorized mechanism) for providing height/focus motion along a third (Z) axis. The process beam head 120 then focuses the process beam 121 down onto the workpiece 102. The process beam controller 154 generates the two- and three-dimensional process beam motion commands that are provided to the process beam actuators 126 in the process beam head 120 to command and control the process beam motion.

The process beam controller 154 may apply corrections to the commanded motion using calibrations to mitigate cumulative temporal and/or spatial errors in the position of the process beam. These calibrations may include, for example, spatial orientation calibrations aligning the process beam head (Scanner frame) to the robot/stage motion path axes as well as calibrations to align to the workpiece/stage (Part frame). One or more non-linear calibrations may also be applied to correct for one or more non-idealities in the optical components within the path of the process beam 121. The process beam head (or scanner) non-linear corrections and calibrations may include optical and mechanical considerations, such as, chromatic aberrations, lens non-idealities, galvo alignment, fiber alignment, and moving mechanical and optics components.

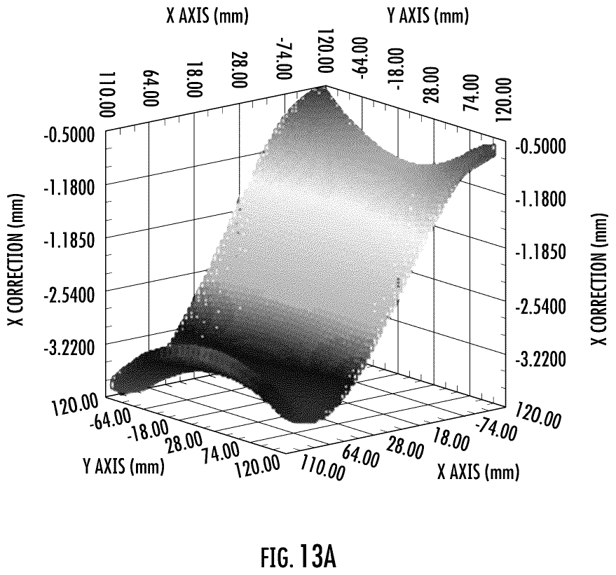

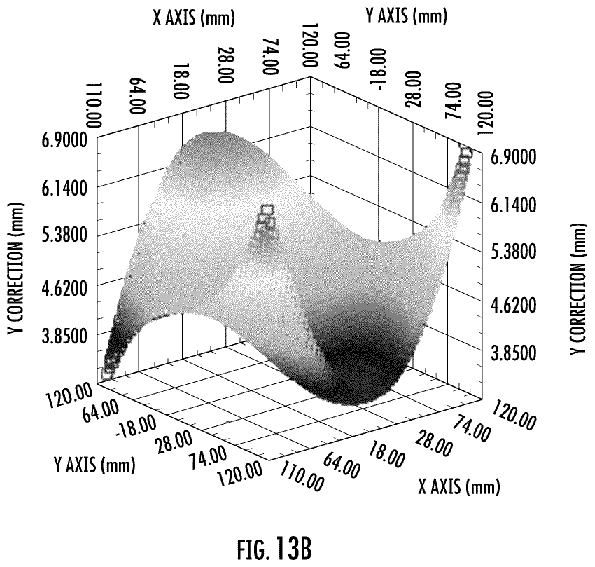

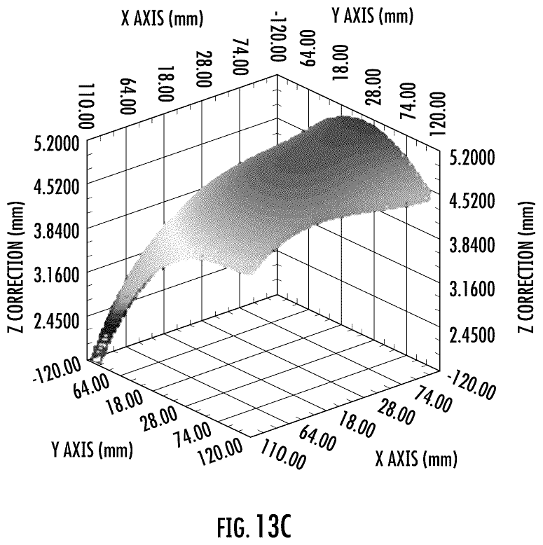

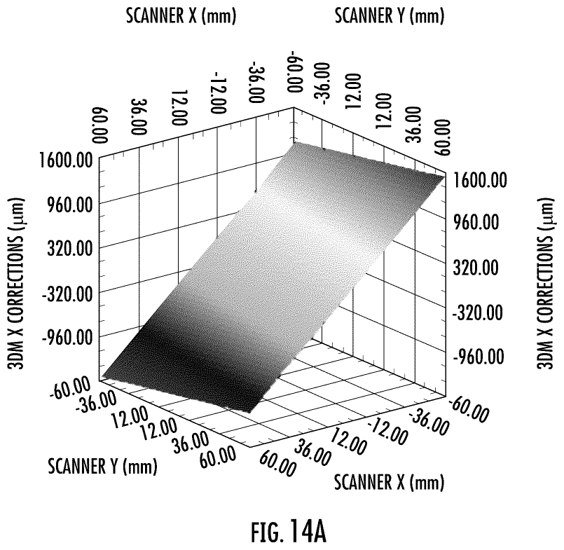

In particular, the process beam controller 154 may apply non-linear corrections or calibrations to position the process beam 121 accurately as well as to focus the process beam 121 to the correct height of the workpiece 102. Examples of scanner non-linear corrections in each of the X, Y, and Z axes within the scanner field of view are illustrated in FIGS. 13A-13C. In particular, these are corrections to the X and Y galvos and the Z actuator positions to correct for the non-idealities based on the commanded X, Y, Z positions to those actuators. Corrections due to these non-idealities may increase and become less accurate the farther from the center of the field-of-view (working area) the process beam is positioned. Optical changes in the system (e.g., a new lens) may require recalibration to account for non-idealities in the new optics.

In some embodiments, the process beam controller 154 may generate motion commands such that the field-of-view (working area) of the processing beam motion is reduced to reduce the overall error correction that may be required and enable more accurate positioning. Limiting the FOV adds speed and introduces less of an angle between the process beam 121 and the workpiece 102, thus reducing focusing issues and obtaining better energy density (and more consistent weld depth). In some applications, the FOV may be reduced from a maximum FOV for the process beam head to a smaller, limited FOV to reduce the impact of calibrations required. In other applications, such as welding with rotary OTF, a larger field of view may be possible with a flat field (wide field) scanner lens. The FOV may be limited as much as possible such that all of the welds during a welding operation may be executed in approximately the same scanner frame of reference position (i.e., approximately same position in the scanner FOV), minimizing differences in the calibrations applied between welds and the variation weld-to-weld.

In addition to the calibrations applied to the motion commanded by the process beam controller 154, the process beam controller 154 may also receive signals from the process beam actuators 126 and provide real time corrections based on the process beam actual motion path. For example, the actual positions of the lateral process beam control mirrors may be measured and commanded positions may be adjusted in real-time to compensate for errors in the process beam position.

In some embodiments, the process beam controller 154 may use “skywriting” techniques when controlling process beam motion to ensure that the process beam 121 is not accelerating or decelerating while the welding is ongoing. In general, “skywriting” refers to controlling the process beam motion and power such that the process beam avoids accelerating and decelerating while the process beam is powered on and welding. According to one example of a “skywriting” technique, the process beam 121 may be accelerated to the programmed speed and the trajectory of the process beam 121 may be smoothly transitioned into the initial trajectory of the weld. The laser is precisely triggered to match the programmed start position and trajectory of the weld on the workpiece. Once the weld is complete, the laser is turned off and the process beam position is moved to the next weld while maintaining a smooth trajectory path. Such a “skywriting” technique allows for the weld to be performed at constant speed and ensures the weld is repeatable.

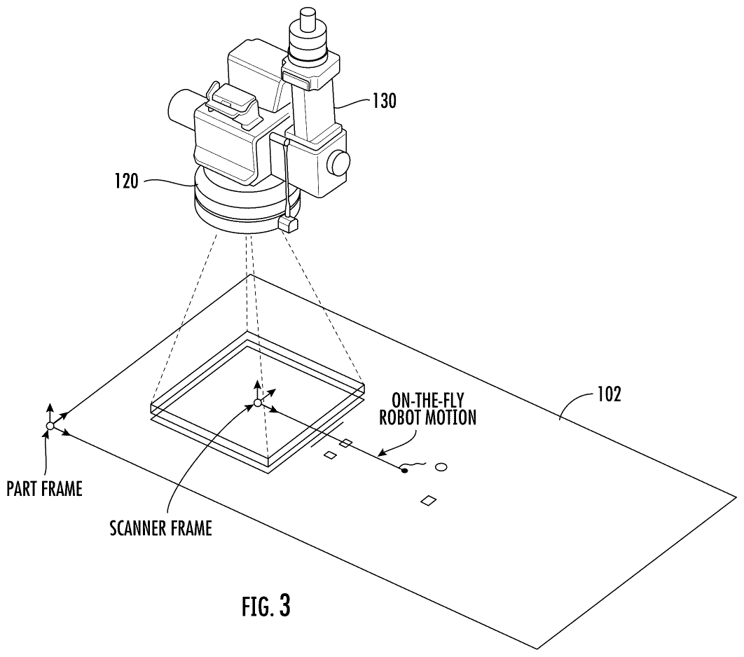

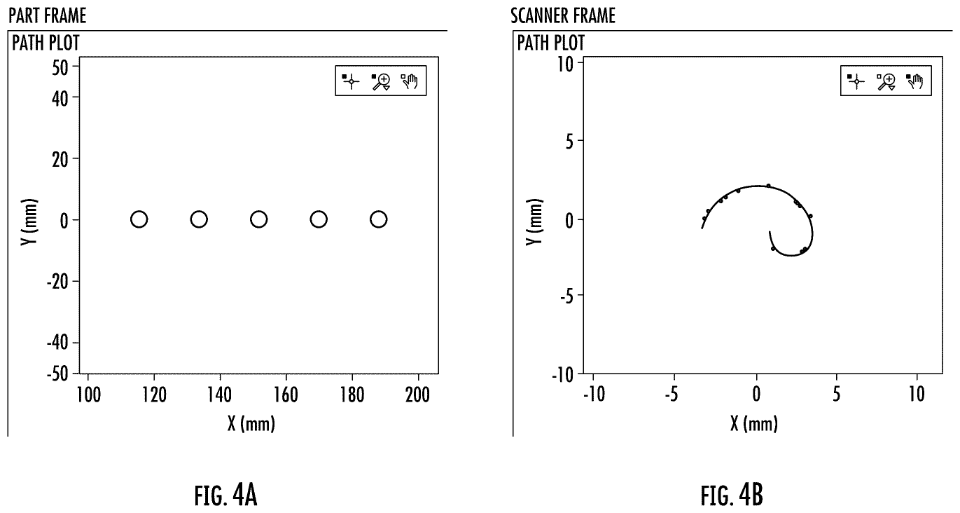

The process beam controller 154 may apply the process beam compensations discussed above regardless of if the system is in the on-the-fly mode or in static mode. In the on-the-fly mode, the process beam controller 154 receives additional input (e.g., R/G motion path data and R/G orientation data) from the robot/gantry controller 152 to plan and compensate for the compounding motion and errors introduced. As shown in FIG. 3, the processing beam motion occurs in a processing beam frame of reference (scanner frame) relative to the OTF motion in the part frame of reference (part frame). For a series of circle welds, for example, FIG. 4A shows the process beam motion path in the part frame of reference and FIG. 4B shows the process beam motion path in the scanner frame of reference.

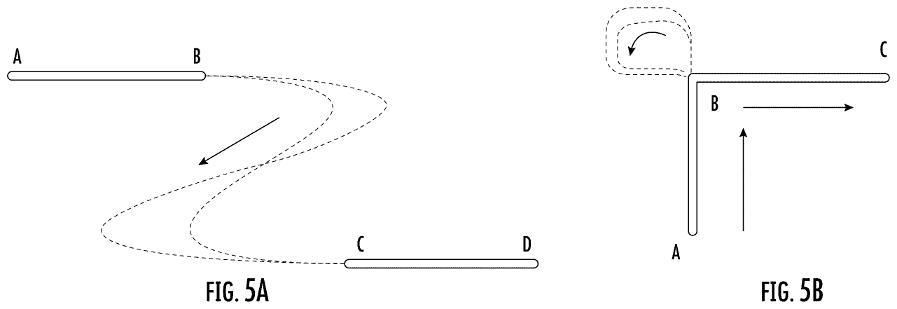

FIGS. 5A and 5B illustrate examples of skywriting motion paths for different weld patterns with the dashed lines representing examples of the motion with the laser turned off while the process beam is positioned to start the next weld. FIG. 5A shows two separate welds A-B and C-D performed in the same direction but at different locations. As shown in FIG. 5A, the process beam performs the weld along A-B, the laser is turned off while moving along one of the dashed lines to the next weld, and then the process beam performs the weld along C-D. FIG. 5B shows a weld A-B-C having two sections in different directions. As shown in FIG. 5B, the process beam performs the weld along section A-B, the laser is turned off while moving along the path of the dashed line, and then the process beam performs the weld along section B-C.

A repeatable pre-recorded robot/gantry/stage motion path can be used for on-the-fly process beam motion path planning and corrections or real-time encoder position feedback may be used for more accurate and repeatable process beam motion by reading and compensating for inconsistencies and errors in the robot motion in real-time. It is also possible to utilize real-time corrections on top of a pre-recorded path.

The process beam controller 154 receives the robot motion path data as an input and plans the relative process beam path required to execute the programmed weld path on the workpiece. As part of this path planning, the process beam controller 154 uses the error mitigation techniques discussed above to make corrections. In a real-time encoder system, the process beam controller 154 additionally uses the actual motion path of the process beam to adjust the process beam motion and further compensate for non-idealities in the robot motion.

Due to the robot motion being relatively imprecise and the recorded motion information having low precision, the process beam controller 154 performs data processing on the recorded robot/stage motion path, which is programed to be a continuous, consistent motion. The data processing may include applying low-pass filtering, general smoothing, re-sampling and interpolation of the motion path data recorded from the robot/stage to create a processed motion path that more closely matches the actual motion path and minimizes the errors introduced. High frequency components of motion signals may be erroneous because the inertia of the moving parts resists acceleration.

In addition to the spatial planning of the on-the-fly welds being performed, the process beam controller 154 also plans the motion between welds, for example, to implement the “skywriting” technique. This motion path planning minimizes the time between welds, which increases productivity, and ensures that the timing is repeatable weld-to-weld and run-to-run. Evaluating timing/motion repeatability from run-to-run is an important step of setting up such a process in some embodiments.

With respect to laser characteristics, the laser controller 158 may control the triggering and power of the process laser 122. When using the “skywriting” feature, for example, the laser controller 158 may keep the laser power constant for the entire duration of welds. Laser power is kept consistent and does not require power adjustments during the weld, due to the constant speed of the process beam motion.

Using an Adjustable Mode Beam (AMB) laser also helps to stabilize the welding process. In particular, using the AMB laser results in a more stable and consistent keyhole, reducing the difficulty (i.e. increasing signal stability) for the OCT measurement during OTF welding. Using an AMB laser in combination with limiting the processing FOV, as discussed above, may further enhance weld quality because the shield function of the ring may be maintained across the entire FOV as opposed to when using a larger FOV where the ring shielding may be less effective at outer edges.

The process beam controller 154 may also control the focus of the process beam 121. The process beam motion path creates a diversity of angles to the workpiece surface in cases where the lens of the process beam head 120 is not telecentric. This angle causes the power distribution on the workpiece 102 to change throughout the welding process and may cause non-idealities in the weld, keyhole dynamics and workpiece surface. This can result in misalignment of the process beam 121 and OCT measurement beam 131 as well as incorrect weld penetration depths. The process beam controller 154 may thus provide consistent laser beam focus and power distribution to maintain a stable keyhole and welding process. Using a single-mode laser helps minimize the size of the focus spot and minimizes the effect of the angular artifacts.

Additionally, maintaining a smaller field-of-view for the process beam, as discussed above, minimizes these angular effects. With a larger field-of-view, the effects due to the angle of the beam relative to the workpiece may be mitigated by compensations to focus, laser power, processing beam and OCT beam alignment.

With respect to OCT beam positioning, as shown in FIG. 2B, the OCT controller 156 commands and controls measuring beam motion provided by the OCT head 130 using measuring beam corrected motion path data. As will be described in greater detail below, the measuring beam corrected motion path data is produced, at least in part, by processing the robot motion path data combined with process beam actual motion path data and by applying corrections.

The OCT measurement beam 131 generated by the OCT monitor 132 exits a fiber optic cable 133 and is optically collimated in the OCT head 130. The OCT actuators 136 actuators in the OCT head 130 may include two galvanometric mirrors (also referred to as a 3D Module) to position the measurement beam for lateral motion and may include movable lenses and a lens moving mechanism (e.g., a motorized mechanism) for providing a third (Z) axis for height/focus adjustment. The process beam head 120 then focuses the OCT measuring beam 131 down onto the workpiece 102 through the same optical path as the process beam (e.g., through the process beam galvanometric mirrors and lenses). The OCT controller 156 generates the two- or three-dimensional OCT beam motion commands that are provided to the OCT actuators 136 to command and control the measuring beam motion.

In some embodiments, the functions of the process beam controller 154 and the OCT controller 156 may be integrated on the same hardware. Such tight integration has benefits in reducing latency and real-time calculation, ultimately reducing the aggregate error between the actual and desired positions of the OCT beam.

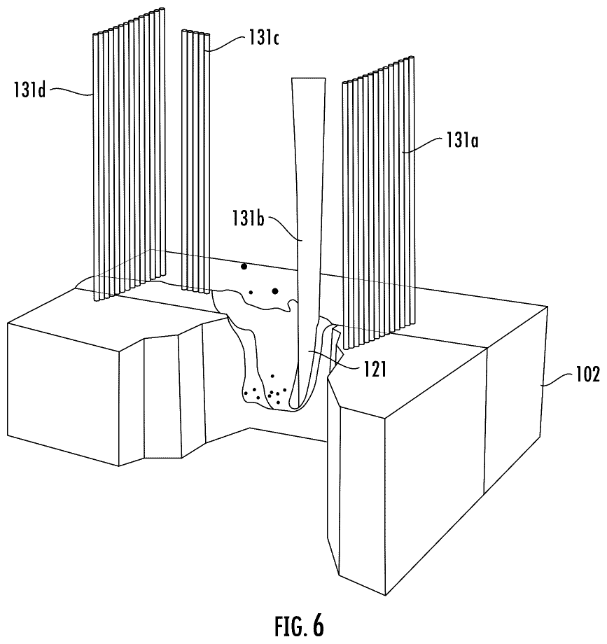

FIG. 6 shows examples of the positioning and motion of the OCT measuring beam 131a-131d relative to the process beam 121 for monitoring and measuring weld characteristics. In one example, an OCT measuring beam 131a may be scanned laterally across the seam ahead of the weld to confirm part alignment. In another example, an OCT measuring beam 131b may be directed into the keyhole (i.e., lagging the process beam 121) to measure weld depth. In a further example, an OCT measuring beam 131c may be scanned along the finished weld to check for defects. In yet another example, an OCT measuring beam 131d may be scanned laterally across the finished weld to measure the weld seam width and shape. Other types of monitoring and measurements are also contemplated and within the scope of the present disclosure.

The OCT controller 156 may apply corrections to the commanded motion using calibrations to mitigate cumulative temporal and/or spatial errors in the position of the OCT measuring beam. These calibrations may include, for example, spatial orientation calibrations aligning the OCT head to the process beam motion path axes. One or more non-linear calibrations may also be applied to correct for one or more non-idealities in the optical components within the path of the OCT measuring beam 131 including both OCT head and process beam head optical components. OCT non-linear corrections or calibrations may include optical and mechanical considerations, such as, chromatic aberrations, lens non-idealities, galvo alignment, fiber alignment, optical path length, OCT to scanner galvo alignment, OCT changes due to scanner movement, and moving mechanical and optics components.

Non-linear calibrations may also be applied to correct for non-idealities resulting from the wavelength differences between the OCT measuring beam 131 and the process beam 121, which cause misalignment of the beams, to position the OCT measuring beam 131 accurately relative to the process beam 121 and on the workpiece 102. In addition to lateral calibrations, vertical (height) calibrations may be made to adjust the focus of the OCT measuring beam 131 to the correct height of the workpiece 102 and optical path length corrections to adjust the measured height of the workpiece 102 during OCT measurements. These OCT beam calibrations may be used to align the OCT measuring beam 131 and the processing beam 121.

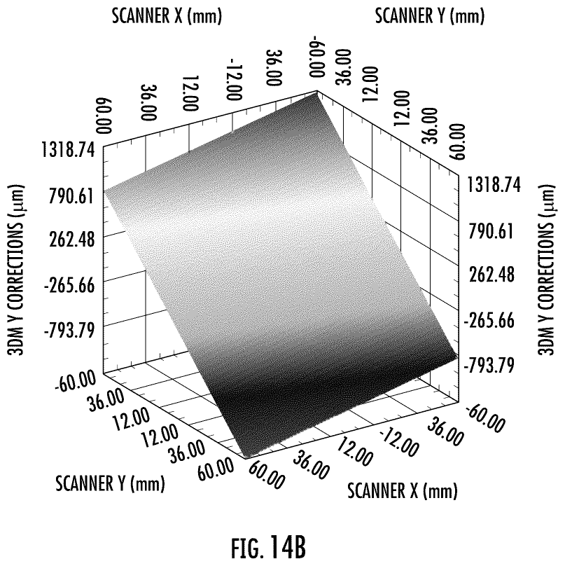

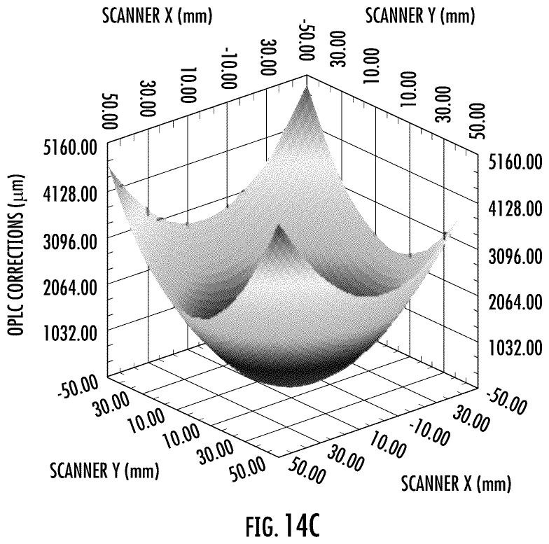

Examples of OCT non-linear corrections relative to the scanner X and Y axes are shown in FIGS. 14A-14C. FIGS. 14A and 14B show X and Y corrections to 3D Module/OCT galvo positions (3DM X and Y corrections) based on combined scanner and 3DM/OCT positioning, where the measuring beam goes from the 3DM/OCT galvos through the scanner optics and galvos. FIG. 14C shows optical path length corrections (OPLC) relative to the scanner X and Y axes, which adjust OCT height measurements to account for the optics. This uses the scanner and 3DM/OCT X, Y, Z positions as an input and provides a Z adjustment of the OCT measurements. Corrections due to these non-idealities may increase and become less accurate the farther from the center of the field-of-view (working area) the OCT measuring beam 131 is positioned. The OCT system uses the same field-of-view (working area) as the process beam 121. Therefore, reducing the field-of-view of the process beam 121, as discussed above, also reduces the overall correction error required for the OCT measuring beam and enables more accurate positioning.

In addition to these calibrations, the OCT controller 156 may apply corrections using actual measuring beam motion path data, for example, based on the OCT actuators 136 in the OCT head 130. For example, the actual positions of the lateral OCT beam control mirrors may be measured and commanded positions may be adjusted in real-time to compensate for errors in the OCT beam position.

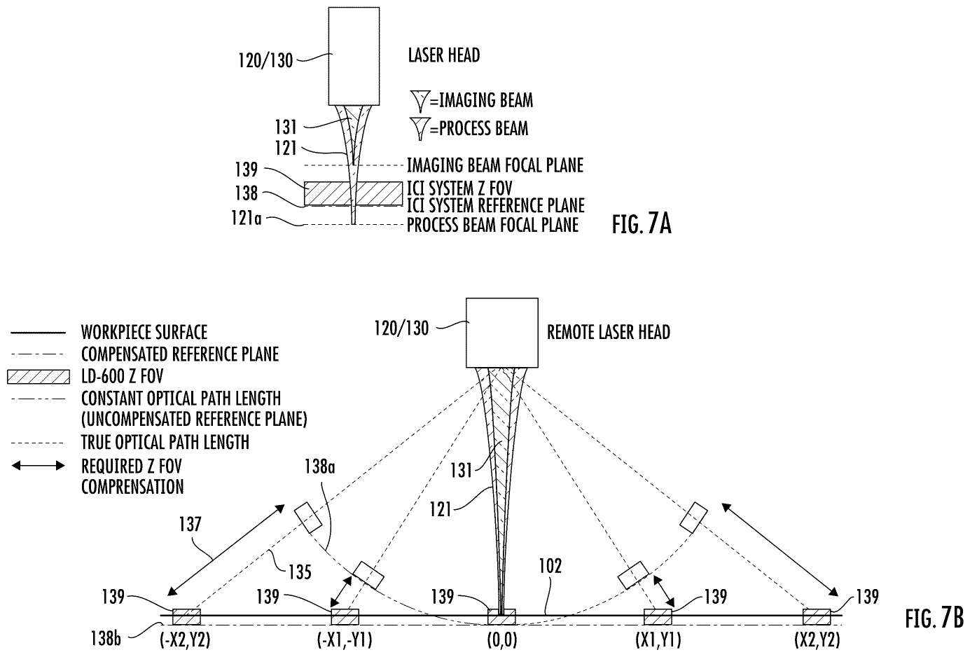

In addition to the lateral field-of-view, the OCT system has a finite imaging field-of-view (along the axis of the measuring beam 131). FIG. 7A shows the imaging field-of-view 139 with the OCT system reference plane 138 relative to the focal plane 121a of the process beam 121. This finite imaging range of the OCT system can be shifted, for example, through a motorized actuator in the OCT head 130. As mentioned above, the calibrations discussed above can be significant the farther the OCT measuring beam 131 is positioned from the center of the lateral field-of-view (working area). Thus, the imaging field-of-view 139 may be shifted when making the lateral positional corrections to enable successful imaging of the workpiece 102, as shown in FIG. 7B. In some embodiments, the OCT controller 156 controls the OCT head 130 to change this imaging field-of-view 139 while the weld is ongoing and a surface reference measurement may be made to accurately measure the height of the weld features in an absolute reference frame. When the imaging beam 131 is scanned away from the center (0,0), for example, the true optical path length 135 is lengthened and a Z FOV compensation 137 in the Z axis may be applied to change the ICI system reference plane 138 from uncompensated reference plane 138a to a compensated reference plane 138b.

Active changes to the imaging field-of-view 139 may cause artifacts in the OCT measurements. In other embodiments, a long imaging field-of-view may be used to avoid or minimize movement of the imaging field-of-view and to avoid having to perform corrections for the imaging field-of-view. Using a swept source OCT system may advantageously allow such a long imaging field-of-view.

As mentioned above, the OCT measuring beam 131 is used to measure the welding process and thus follows the process beam 121 throughout the welding process while measuring at specific locations on the workpiece around the process beam (e.g., inside the keyhole, pre-weld seam, post-weld bead as shown in FIG. 6). The OCT measuring beam 131 may be focused onto the workpiece 102 in the same position as the process beam 121. Due to differences in the beam characteristics, a calibration routine may be used to achieve this alignment. Additionally, in some processes, the OCT focus is better suited to be closer to the keyhole target depth and may be calibrated to that position.

To position the OCT measuring beam 131 for measurements, the OCT controller 154 also receives an input of the motion paths for both the process beam 121 and the robot system 110. Since the process beam controller 154 has post-processed the robot motion path data during process beam path planning, the OCT controller 154 uses this post-processed path data in addition to the process beam motion path data. A repeatable pre-recorded motion path may be used for the OCT beam motion planning and corrections and/or real-time position feedback can be used for more accurate and repeatable OCT beam motion by reading and compensating for inconsistencies and errors in the process beam motion in real-time.

The OCT controller 156 receives the combined robot/gantry and process beam motion path data as an input and plans the relative OCT measuring beam path required to perform the programmed measurements on the workpiece. As part of this path planning, the OCT controller 156 may use the error mitigation techniques discussed above to provide corrections. In a real-time position feedback system, the OCT controller 156 additionally uses the actual motion to adjust the OCT beam motion to compensate for non-idealities in the process beam motion.

Pre-recorded combined robot/gantry/stage and process beam motion paths may not have the required temporal precision for direct use in the motion path planning performed by the OCT controller 156. The pre-recorded data may also contain artifacts due to the recording process and data transfer limitations. Additional precision may be needed to achieve alignment with the welding keyhole (e.g., about 10 μm width).

Similar to the processing of the robot/gantry motion path data in the process beam controller 154, the OCT controller 156 may perform data processing on the recorded combined robot and process beam motion path data including low-pass filtering, data artifact rejection, smoothing, re-sampling and interpolation.

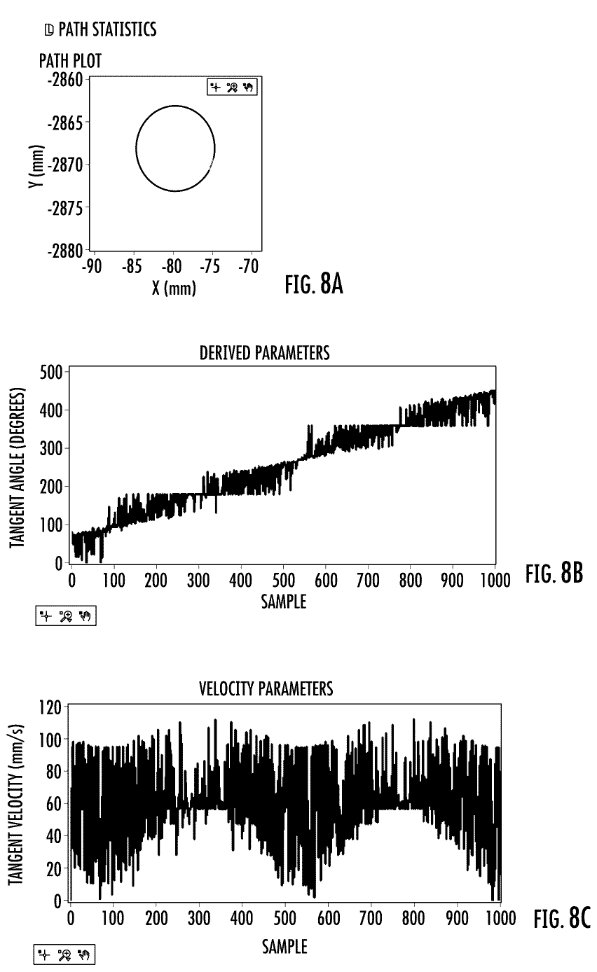

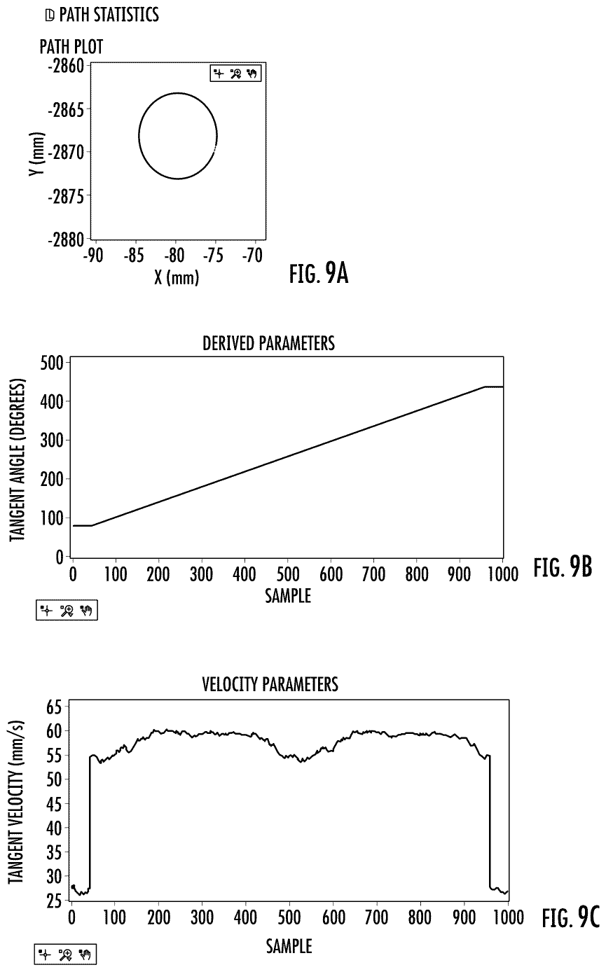

FIGS. 8A-8C illustrate the path plot for a circle weld and the associated parameters derived from the combined process beam and robot/gantry motion path data provided to the OCT controller 156 pre-processing, i.e., before processing in the OCT controller 156 as discussed above. As shown, the parameters (representing both the path and velocity of the process beam during a welding operation) derived from the combined path data pre-processing include noise, for example, generated by the encoders in the robot/gantry system. FIGS. 9A-9C illustrate the path plot for a circle weld and the associated parameters derived from the combined process beam and robot/gantry motion path data post processing, i.e., after processing in the OCT controller 156 as discussed above. As shown in the parameters derived from the combined data post processing, the processing of the combined motion path data rejects artifacts and smooths the data.

In a pre-recorded process, consistent and repeatable run-to-run timing helps to achieve the precision required to align the OCT measurements to the keyhole of the weld process. By performing multiple recordings and analyzing their consistency to each other, the OCT system can identify system-level inconsistencies in the timing and motion paths of the various parts of the system before the welding process occurs. This may use a “Dry run” where the system in concert performs the welding motions, processing steps and recordings without the laser enabled (no laser power is emitted onto the workpiece). If an inconsistency is identified, the system can be investigated for mechanical flaws or programming errors which would cause OCT alignment or welding process inconsistencies.

The OCT controller 156 may also perform corrections to the process beam motion path using OCT measurements. When using real-time feedback of the OCT measurements in the system, additional corrections can be made to adjust for the dynamically changing process. This can include process beam alignment, laser power, and focus adjustments based on the OCT measurements. In addition, the OCT beam alignment can be adjusted in real-time to compensate for process beam alignment, angles and focus changes.

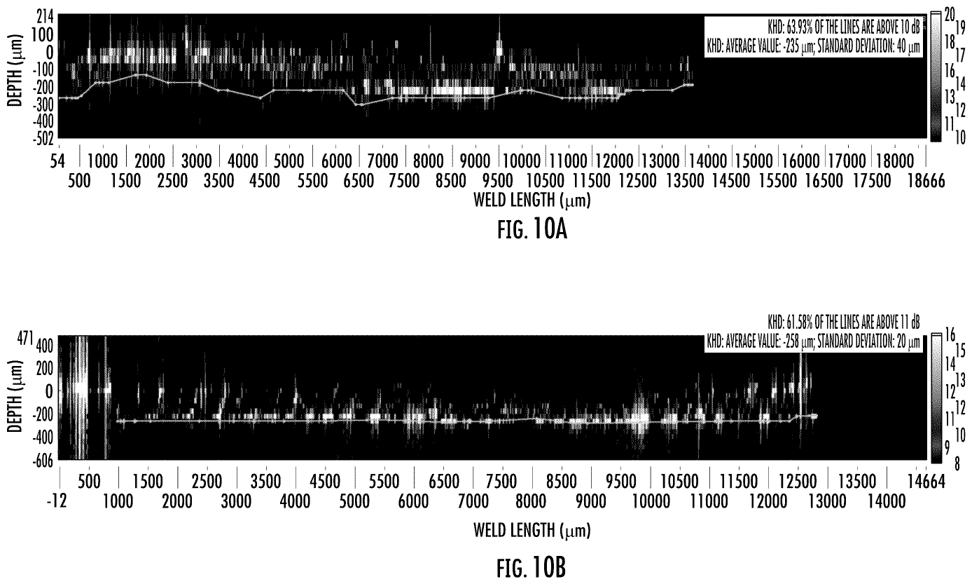

The cumulation of the recording, processing, real-time feedback, motion path planning and measurements discussed above allow for the OCT system to accurately align to and measure the keyhole (e.g., within about 10 μm) of the on-the-fly welding process. FIGS. 10A and 10B illustrate OCT measurement data without compensations and with compensations, respectively. In the illustrated example in FIGS. 10A and 10B, the OCT measurement data represents the measured depth of a keyhole along the weld length. Applying general smoothing, re-sampling and interpolation of the combined motion path data creates a processed motion path that more closely matches the actual combined motion path to a higher precision (spatially and temporally), which minimizes the errors introduced in the OCT path planning. As shown, there is significant reduction in the bright surface data (near 0 depth) due to the proper alignment of the measurement beam with the keyhole.

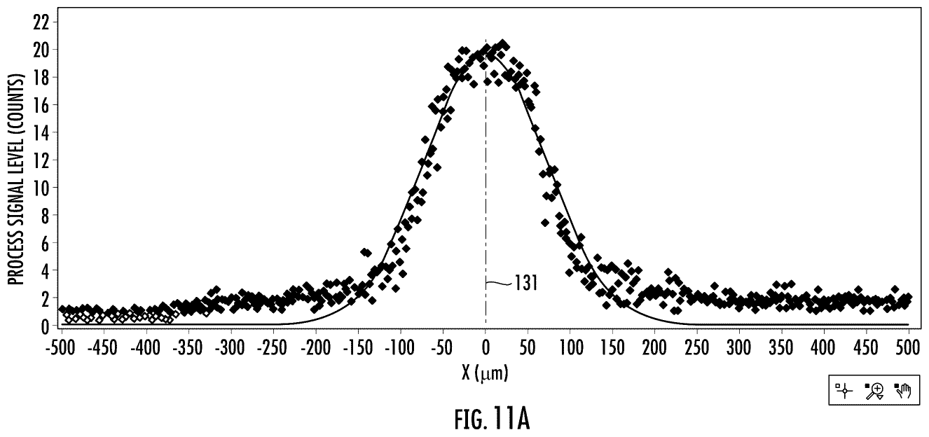

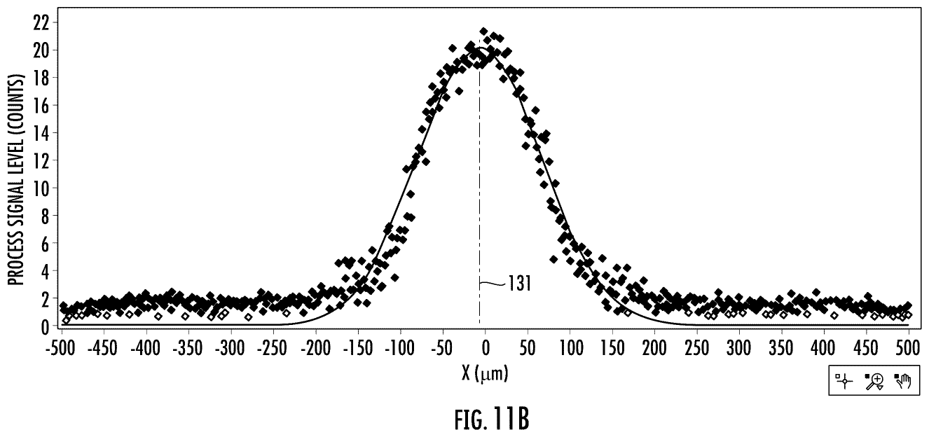

According to one example of a calibration, the system may be calibrated such that the measuring beam is in focus with the process beam at the scanner origin (0,0). This alignment may be achieved, for example, with Advanced Process Beam Alignment (APBA) where the OCT head is used to scan and center the measuring beam on the radiation pattern of the process beam while the process beam is firing. FIGS. 11A and 11B illustrate an example of OCT Advanced Process Beam Alignment in the scanner X and Y axes, respectively, with the measuring beam 131 being aligned relative to the peak of the process signal level at the scanner origin. This calibration may be advantageous, for example, to ensure consistent keyhole alignment when performing OCT keyhole measurements during OTF welding of non-linear paths (e.g., OTF circular welds) at high speeds.

The systems and methods for OTF welding using OCT, as disclosed herein, may be used in various types of welding processes including, for example, linear OTF welding, rotary OTF welding, and infinite field of view (FOV) OTF welding, as will be described in greater detail below. Using the measurement and compensation techniques described herein, the OTF/OCT control system is capable of controlling the measuring beam motion to monitor weld depth throughout the welding operation at welding speeds up to 1000 mm/s, although higher weld speeds may be possible. In the examples described herein, the OTF/OCT control system was able to control the measuring beam motion to monitor weld depth throughout the welding operation at welding speeds in a range of about 300 mm/s to 1000 mm/s.

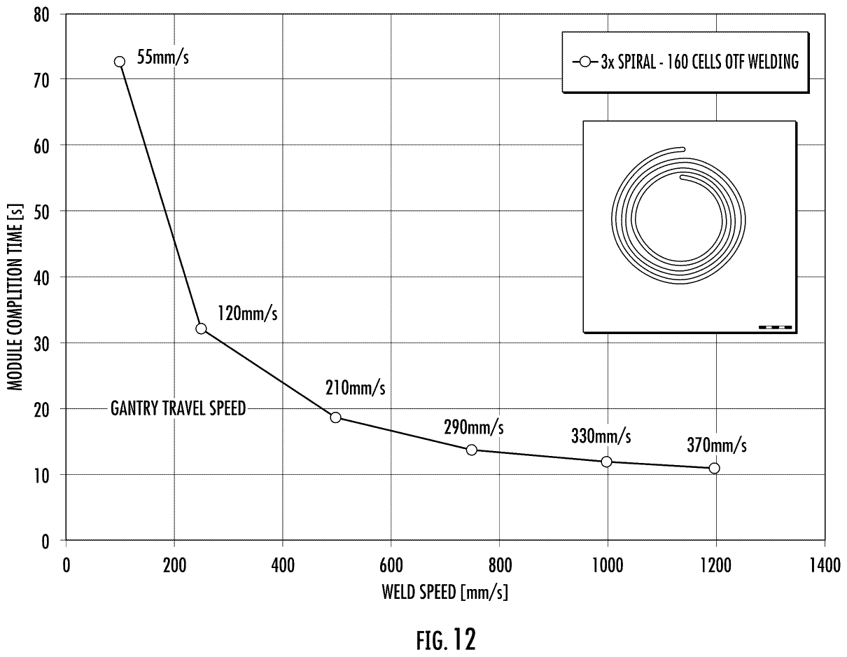

For linear OTF welding, the process beam head and OCT head are moved linearly relative to a workpiece while the process beam head and the OCT head move the process beam and the OCT measuring beam, respectively, to achieve the desired weld pattern. During linear OTF welding using a gantry, the gantry speed may depend on the weld speed and weld length. A shorter weld and faster weld speed allows for higher gantry speeds, so shorter completion cycle time can be achieved. Cycle time also depends on module design such as cell to cell distance and amount of cell rows requiring gantry turnarounds when using OTF welding to connect battery busbars to cells. Welding multiple rows in a single gantry direction, for example, decreases cycle time due to less gantry turnaround. FIG. 12 illustrates one example of module completion time as a function of weld speed for a 3× spiral weld of 160 cells using linear OTF welding. In this example, up to 16 welds per second may be feasible with circle welds at 1 m/sec. Keyhole depth and weld depth measurements may be obtained using OCT monitoring during linear OTF welding with higher weld and gantry speeds, for example, with a weld speed of 1000 mm/s, a gantry speed of 300 mm/s, and a laser power of 500 W.

Linear OTF welding may be used, for example, for laser welding of current collectors/bus bars to cylindrical cells (e.g., 18650 type, 21700 type, 4680 type) in a 3-axis gantry system using an HP scanner head as the process beam head and using an OCT head to monitor weld keyhole depth for weld quality control. In one example, the welded materials may include 0.1 mm-0.5 mm copper, aluminum or steel (e.g., for the bus bar) and 0.3 mm-0.8 mm Ni-plated steel, aluminum or nickel (e.g., for the cell terminals). One example of linear OTF welding with OCT for busbar welding is capable of welding 160 cells with a cycle time of 13 sec and throughput of 720 cells/min. In another example of linear OTF welding with OCT monitoring to confirm weld depth, the welded materials include 0.5 mm aluminum busbar welded to 0.8 mm Ni-plated steel with a spiral weld shape.

For rotary OTF welding, the workpiece is rotated while the process beam head and the OCT head move the process beam and the OCT measuring beam, respectively, to achieve the desired weld pattern. Rotary OTF welding may be used, for example, for laser current collector welding of connector plates to jelly roll for cylindrical cells on a rotating conveyor with cell carriers installed using an HP scanner head. In one example, the welded materials may include 0.1 mm-0.2 mm copper (connector plate) and 0.1 mm-0.3 mm aluminum (connector plate). One example of such current collector welding using rotary OTF welding is capable of 12 cells per rotation with a cycle time of 3.6 sec and throughput of 200 ppm.

Infinite FOV OTF welding may be used to provide high throughput laser welding of continuous seams larger than the field of view of an HP scanner head and/or welding of closed contour paths for hermetic sealing of an assembly. Infinite FOV welding may use weld path optimization to precisely control welding speed and acceleration/deceleration along the weld trajectory. Infinite FOV welding may be used, for example, for welding of a fuel cell assembly with weld speeds of 300 mm/s or for welding of a cooling plate assembly with weld speeds of 400 mm/s. In one example, the welded materials may include 0.6 mm aluminum welding to 1.0 mm aluminum sheet with a weld speed up to 500 mm/s and weld length up to several meters. One example of an infinite FOV weld process with LDD monitoring to confirm weld depth was used to weld 0.6 mm aluminum to 1.0 mm aluminum for a cooling plate assembly with a continuous oval racetrack weld path.

In one example of linear OTF welding using OCT, consistent with the present disclosure, the system was able to acquire corresponding depth data from an LDD inline weld process monitoring system while welding at 650 mm/sec and moving the gantry at 300 mm/sec. This was done with a series of 20 spiral welds (3 mm×3 mm dimensionally) while moving the process beam head and the LDD head on a gantry and keeping the parts fixed. This example demonstrates that the systems and methods for OTF welding using OCT, consistent with the present disclosure, are capable of welding faster with smaller welds.

In another example of linear OTF welding using OCT, consistent with the present disclosure, the system was able to acquire corresponding depth data from an LDD inline weld process monitoring system while welding at ˜450 mm/sec and moving the gantry at 400 mm/sec. This was done welding a 1 racetrack shape weld (800 cm in total length) while moving the process beam head and the LDD head on a gantry and keeping the part fixed. This example demonstrates that the systems and methods for OTF welding using OCT, consistent with the present disclosure, are capable of welding faster and with longer welds.

Accordingly, the systems and methods for OTF welding using OCT, disclosed herein, ensure the accuracy of the OCT measurements by using measurement and compensation techniques to minimize errors in welding path data.

Embodiments of the methods described herein may be implemented using a controller, processor, and/or other programmable device. To that end, the methods described herein may be implemented on a tangible, non-transitory computer readable medium having instructions stored thereon that when executed by one or more processors perform the methods. The storage medium may include any type of tangible medium, for example, any type of disk optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The functions of the various elements shown in the figures, including any functional blocks labeled as a controller or processor, may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term controller or processor should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A system for on-the-fly (OTF) welding using optical coherence tomography (OCT), the system comprising:
a process laser for generating a process beam;
a process beam head configured to direct the process beam to a workpiece and configured to provide motion of the process beam relative to the workpiece in accordance with process beam corrected motion path data for performing a welding operation at a weld site on the workpiece;
an OCT monitor configured to generate an OCT measuring beam and configured to receive a reflected OCT measuring beam and configured to perform optical coherence tomography;
an OCT head configured to direct the OCT measuring beam to the workpiece and configured to provide motion of the OCT measuring beam relative to the workpiece in accordance with measuring beam corrected motion path data for performing measurements at the weld site on the workpiece;
a robot system supporting the process beam head and the OCT head and supporting the workpiece, wherein the robot system is configured to provide relative motion between the process beam head and the OCT head and the workpiece in accordance with robot motion path data to perform OTF welding; and
an OTF/OCT control system coupled to the process laser, the process beam head, the OCT monitor, the OCT head, and the robot system, wherein the OTF/OCT control system is configured to:
control the relative motion provided by the robot system between the process beam head and the OCT head and the workpiece using the robot motion path data;
control the process beam motion provided by the process beam head using the process beam corrected motion path data, wherein the process beam corrected motion path data is produced, at least in part, by processing the robot motion path data and by applying corrections using at least one non-linear calibration to correct for at least one optical non-ideality; and
control the measuring beam motion provided by the OCT head using the measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality.

2. The system of claim 1, wherein the OTF/OCT control system is configured to control the measuring beam motion such that the OCT measuring beam aligns within a keyhole formed on the workpiece during the welding operation.

3. The system of claim 1, wherein the OTF/OCT control system is configured to control the measuring beam motion with an accuracy in a range of about 10 μm throughout the welding operation.

4. The system of claim 1, wherein the OTF/OCT control system is configured to control the measuring beam motion to monitor weld depth throughout the welding operation at welding speeds in a range of 300 to 1000 mm/s.

5. The system of claim 1, wherein the OTF/OCT control system is also configured to apply corrections to the process beam corrected motion path data and the measuring beam corrected motion path data using actual process beam motion path data and actual measuring beam motion path data, respectively.

6. The system of claim 1, wherein the OTF/OCT control system is configured to control triggering of the process beam and the process beam motion such that the process beam is not accelerating or decelerating during OTF welding.

7. The system of claim 1, wherein the OTF/OCT control system is configured to control the process beam motion such that the process beam moves within a limited field of view, which is less than a maximum field of view for the process beam head.

8. The system of claim 1, wherein the process laser is an adjustable mode beam (AMB) laser.

9. The system of claim 1, wherein the process laser is a single mode laser.

10. The system of claim 1, wherein the OTF/OCT control system is configured to process the robot motion path data by low pass filtering, smoothing, re-sampling and interpolation of the robot motion path data.

11. The system of claim 1, wherein the OTF/OCT control system is configured to process the combined process beam actual motion path data and robot motion path data by low pass filtering, data artifact rejection, smoothing, re-sampling and interpolation of the combined process beam actual motion path data and robot motion path data.

12. The system of claim 1, wherein the OTF/OCT control system is configured to apply corrections to produce the measuring beam corrected motion path data by applying a Z axis FOV compensation such that an imaging field of view along the Z axis corresponds with the workpiece as the OCT measuring beam moves with the process beam through different angles relative to the workpiece.

13. The system of claim 1, wherein the process beam head includes beam delivery optics for directing the process beam to the workpiece and process beam actuators for providing the process beam motion.

14. The system of claim 1, wherein the OCT head includes beam delivery optics for directing the OCT measuring beam to the workpiece and measuring beam actuators for providing the measuring beam motion.

15. The system of claim 1, wherein the robot system is configured to provide motion of the process beam head and the OCT head while the workpiece is static.

16. The system of claim 1, wherein OTF/OCT control system is configured to control motion by the robot system to perform linear OTF welding with OCT monitoring and to control the process beam motion to perform a series of spiral shape welds.

17. The system of claim 1, wherein OTF/OCT control system is configured to control motion by the robot system to perform linear OTF welding and to control the process beam motion to perform a racetrack shape weld.

18. The system of claim 1, wherein the robot system is configured to provide motion of the workpiece while the process beam head and the OCT head are static.

19. The system of claim 1, wherein the robot system includes a gantry robot supporting and moving the process beam head and the OCT head.

20. A system for controlling and monitoring on-the-fly (OTF) welding using optical coherence tomography (OCT), the system comprising:
a robot controller configured to control relative motion provided by a robot system between a process beam head and an OCT head and a workpiece using robot motion path data;
a process beam controller configured to control process beam motion provided by the process beam head using process beam corrected motion path data, wherein the process beam corrected motion path data is produced, at least in part, by processing the robot motion path data and by applying corrections using at least one non-linear calibration to correct for at least one optical non-ideality;
an OCT measuring beam controller configured to control measuring beam motion provided by the OCT head using measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality; and
a laser controller configured to control powering of a laser source.

21. A system for controlling and monitoring on-the-fly (OTF) welding using optical coherence tomography (OCT), the system comprising:
processing circuitry programmed to:
control relative motion provided by a robot system between a process beam head and an OCT head and a workpiece using robot motion path data;
control process beam motion provided by the process beam head using process beam corrected motion path data, wherein the process beam corrected motion path data is produced, at least in part, by processing the robot motion path data and by applying corrections using at least one non-linear calibration to correct for at least one optical non-ideality;
control measuring beam motion provided by the OCT head using measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality; and
control powering of a laser source.

22. A non-transitory machine-readable medium including instructions, which when executed, cause processing circuitry to perform operations to:
control relative motion provided by a robot system between a process beam head and an OCT head and a workpiece using robot motion path data;
control process beam motion provided by the process beam head using process beam corrected motion path data, wherein the process beam corrected motion path data is produced, at least in part, by processing the robot motion path data and by applying corrections using at least one non-linear calibration to correct for at least one optical non-ideality;
control measuring beam motion provided by the OCT head using measuring beam corrected motion path data, wherein the measuring beam corrected motion path data is produced, at least in part, by processing the robot motion path data combined with process beam actual motion path data and by applying corrections using at least one non-linear calibration to correct for at least one optical non-ideality; and
control powering of a laser source.
